(19) United States
(12) Patent Application Publication
(10) Pub. No.: US 2024/0313884 A1
(43) Pub. Date: Sep. 19, 2024

(54) SYSTEMS AND METHODS OF GUIDED WIRELESS COMMUNICATION RATE ADAPTATION

(71) Applicant: Meta Platforms Technologies, LLC, Menlo Park, CA (US)

(72) Inventors: Ding Li, Fremont, CA (US); Liying Xu, Saratoga, CA (US); Chao-Fang Shih, San Jose, CA (US); Neelakantan Nurani Krishnan, San Jose, CA (US); Guoqing Li, Cupertino, CA (US); Abhishek Kumar Agrawal, Bellevue, WA (US)

(73) Assignee: Meta Platforms Technologies, LLC, Menlo Park, CA (US)

(21) Appl. No.: 18/425,201

(22) Filed: Jan. 29, 2024

Related U.S. Application Data
(60) Provisional application No. 63/452,008, filed on Mar. 14, 2023.

(51) Int. Cl. H04L 1/00

(52) U.S. Cl. CPC H04L 1/0009; H04L 1/0003

(57) ABSTRACT

Disclosed herein are aspects related to a device that can include a wireless communication interface and one or more processors. The wireless communication interface can transmit, using a wireless connection with a remote device, one or more data elements to the remote device. The one or more processors can identify a condition of the wireless connection, determine a rate, for transmission of the one or more data elements, based at least on the condition, retrieve a signal from the remote device indicative of at least one criterion for use of the one or more data elements, update the rate based at least on the at least one criterion to determine an updated rate for transmission of the one or more data elements to the remote device, and cause the wireless communication interface to transmit, at the updated rate, the one or more data elements to the remote device.

### CROSS-REFERENCE TO RELATED APPLICATIONS

The present application claims the benefit of and priority to U.S. Provisional Application No. 63/452,008, filed Mar. 14, 2023, the disclosure of which is incorporated herein by reference in its entirety.

### FIELD OF DISCLOSURE

The present disclosure is generally related to communication for rendering artificial, mixed, virtual, or extended reality, including but not limited to systems and methods for systems and methods of prioritized data discard for wireless communication.

### BACKGROUND

Artificial/extended reality (XR) such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space).

### SUMMARY

Systems that implement XR can transmit data to and receive data from remote devices, such as network base stations, as part of providing XR experiences. Due to various factors including size, weight, and power considerations, it can be useful for such systems, such as portable user equipment (UE) devices, to control rates of communication of data relative to channel conditions, such as signal to interference and noise (SINR) ratios. However, such control can affect quality of service (QOS) of the XR experience, such as by affecting latency; similarly, XR data, such as video frames to be presented in an order, may be expected to be delivered according to a periodic schedule (e.g., frame rate), and thus some rate control approaches can result in situations such as high throughput but also high packet error rates (PERs), which can lead to higher latency.

Systems and methods in accordance with the present disclosure can allow for more effective communication of network data, including XR data, by allowing for a transmitting device to use information regarding a wireless connection, such as a wireless local area network (WLAN) channel connection (e.g., a WiFi channel connection), with a receiving device, in order to more effectively adapt how the data is transmitted. For example, the transmitting device can use an indication that the data is to be used for latency-sensitive applications in order to reduce an MCS and/or data rate of the transmission (or select a relatively low MCS and/or data rate), such as to facilitating lowering the packet error rate; the transmitting device can use an indication that the data is to be used for throughput-sensitive applications in order to increase an MCS and/or data rate of the transmission (or select a relatively high MCS and/or data rate).

Various implementations disclosed herein are related to a device that can include a wireless communication interface and one or more processors. The wireless communication interface can transmit, using a wireless connection with a remote device, one or more data elements to the remote device. The one or more processors can identify a condition of the wireless connection. The one or more processors can determine a rate, for transmission of the one or more data elements, based at least on the condition, retrieve a signal from the remote device indicative of at least one criterion for use of the one or more data elements. The one or more processors can update the rate based at least on the at least one criterion to determine an updated rate for transmission of the one or more data elements to the remote device. The one or more processors can cause the wireless communication interface to transmit, at the updated rate, the one or more data elements to the remote device.

In some implementations, the at least one criterion includes at least one of a packet error rate, a latency criterion, or a throughput criterion. The one or more data elements can correspond to video data (or types of XR data). The one or more processors can identify the condition based on at least one of a signal to noise ratio (SNR) of the wireless connection or a signal to interference and noise ratio (SINR) of the wireless connection.

In some implementations, the wireless communication interface includes a WLAN/WiFi radio. The one or more processors can determine the rate, based at least on the condition, as a selection of a modulation coding scheme (MCS) for WLAN/WiFi communication over the wireless connection. The one or more processors can update the rate by selecting a higher MCS responsive to the at least one criterion indicating a throughput-sensitive use for the one or more data elements. The one or more processors can update the rate by selecting a lower MCS responsive to the at least one criterion indicating a latency-sensitive use for the one or more data elements. In some implementations, the one or more processors are to retrieve the at least one criterion from a two bit data structure in a header of the signal from the remote device.

Various implementations disclosed herein relate to a system that can include one or more processors. The one or more processors can identify a condition of a wireless connection with a remote device. The one or more processors can determine a rate, for transmission of the one or more data elements, based at least on the condition. The one or more processors can retrieve a signal indicative of at least one criterion for use of the one or more data elements. The one or more processors can update the rate based at least on the at least one criterion to determine an updated rate for transmission of the one or more data elements to the remote device. The one or more processors can cause a wireless communication interface to transmit, at the updated rate, the one or more data elements to the remote device.

In some implementations, the at least one criterion includes at least one of a packet error rate, a latency criterion, or a throughput criterion. The one or more data elements can correspond to video data. The one or more processors can identify the condition based on at least one of a signal to noise ratio (SNR) of the wireless connection or a signal to interference and noise ratio (SINR) of the wireless connection.

In some implementations, the wireless communication interface includes a WLAN/WiFi radio. The one or more processors can determine the rate, based at least on the condition, as a selection of a modulation coding scheme (MCS) for WLAN/WiFi communication over the wireless connection. The one or more processors can update the rate by selecting a higher MCS responsive to the at least one criterion indicating a throughput-sensitive use for the one or more data elements. The one or more processors can update the rate by selecting a lower MCS responsive to the at least one criterion indicating a latency-sensitive use for the one or more data elements. In some implementations, the one or more processors are to retrieve the at least one criterion from a two bit data structure in a header of the signal from the remote device.

Various implementations disclosed herein relate to a method. The method can include detecting, by one or more processors, a condition of a wireless connection with a remote device. The method can include determining, by the one or more processors, based at least on the condition, a rate for transmission of the one or more data elements. The method can include retrieving, by the one or more processors, a signal indicative of at least one criterion for use of the one or more data elements. The method can include updating, by the one or more processors, the rate based at least on the at least one criterion to determine an updated rate for transmission of the one or more data elements to the remote device. The method can include causing, by the one or more processors, a wireless communication interface to transmit, at the updated rate, the one or more data elements to the remote device.

In some implementations, the at least one criterion includes at least one of a packet error rate, a latency criterion, or a throughput criterion. The one or more data elements can correspond to video data. The method can include identifying the condition based on at least one of a signal to noise ratio (SNR) of the wireless connection or a signal to interference and noise ratio (SINR) of the wireless connection.

In some implementations, the wireless communication interface includes a WLAN/WiFi radio. The method can include determining the rate, based at least on the condition, as a selection of a modulation coding scheme (MCS) for WLAN/WiFi communication over the wireless connection. The method can include updating the rate by selecting a higher MCS responsive to the at least one criterion indicating a throughput-sensitive use for the one or more data elements. The method can include updating the rate by selecting a lower MCS responsive to the at least one criterion indicating a latency-sensitive use for the one or more data elements. In some implementations, the method includes retrieving the at least one criterion from a two bit data structure in a header of the signal from the remote device.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a diagram of an example wireless communication system, according to an example implementation of the present disclosure.

FIG. 5 is a block diagram of a system for network communications, according to an example implementation of the present disclosure.

FIG. 6 is a schematic diagram of rate adaptation processes, according to an example implementation of the present disclosure.

FIG. 7 is a flow chart of a method of guided rate adaptation, according to an example implementation of the present disclosure.

### DETAILED DESCRIPTION

Before turning to the figures, which illustrate certain implementations in detail, it should be understood that the present disclosure is not limited to the details or methodology set forth in the description or illustrated in the figures. It should also be understood that the terminology used herein is for the purpose of description only and should not be regarded as limiting.

Systems and methods in accordance with the present disclosure are related to a communication system that can facilitate more effective WLAN/WiFi rate adaptation, including using peer and/or receiver-side guidance. For example, under various conditions, WLAN/WiFi rate adaptation processes, such as physical rate (phy rate) processes, may be triggered yet may result in suboptimal communication with a given receiving device. For instance, for low latency applications, such as XR applications, some rate adaptation processes (e.g., default rate adaptation algorithms) can prioritize high throughput, but may lead to greater packet error rate and in turn higher latencies. In some implementations, XR devices can have multiple radio circuits operating concurrently (e.g., over 2.4 GHz WLAN/WiFi), which can lead to in-device coexistence issues; in such rate adaptation processes, throughput can decrease and packet drops can be expected, in which case both throughput and PER targets may not be met despite the rate adaptation processes. Under fast changing channel conditions (e.g., when channel coherence time is shorter or much shorter than rate adaptation PER periods), the rate adaptation processes may not converge to a consistent rate control, such as by instead continually switching between different rate controls (e.g., modulation control schemes (MCSs)), such as between higher and lower rates as signal to noise ratio (SNR) and/or signal to interference and noise ratio (SINR) continually change. As such, under various conditions, there can be a mismatch between a rate adaption that a transmitting device selects according to predetermined criteria (e.g., one or more thresholds) and resulting communication parameters (e.g., PER, throughput, latency) associated with the data packets being communicated and/or the use of the data packets by the receiving device, relative to target metrics for those communication parameters.

Systems and methods in accordance with the present disclosure can facilitate more effective rate adaptations by transmitting devices (e.g., transmitting peers, access points (APs), etc.). For example, systems and methods in accordance with the present disclosure can enable receiving devices (e.g., receiving peers, user equipment (UEs), VR/AR devices, etc.) to provide a signal to the transmitting device indicative of a criteria for communication to guide the rate adaptation performed by the transmitting device. In some implementations, the receiving device uses local information (e.g., latency, throughput, and/or packet error rates, such as detected values and/or target values or criteria for such information, or other information indicative of downlink (DL) conditions at the receiving device) to determine the signal to provide to the transmitting device. For example, the receiving device can provide various indications to the transmitting device including but not limited to a selection of a rate adaption process or a range of rate adaptation processes; a detected or target value of a communication criteria or ranges thereof; or various combinations thereof. For example, receiving device can indicate to the transmitting device to adapt (e.g., lower) a rate in a manner targeted for reducing retransmissions (e.g., reducing PERs), so that latency can be reduced. This can include, for example, requesting the transmitting device to step down to a rate; step down to a range of rates; or propose a rate or range of rates. In some implementations, the receiving device can provide the signal to adapt the rate according to SNR and/or SINR measures. In some implementations, the receiving device can indicate a prioritization of latency over throughput (e.g., for low latency applications), responsive to which the transmitting device can use a relatively low PER target to perform rate adaptations. In some implementations, the receiving device can indicate a prioritization of throughput over latency (e.g., for high throughput and/or non-latency sensitive applications), responsive to which the transmitting device can use a relatively high PER target to perform rate adaptations.

In some implementations, a device includes a wireless communication interface and one or more processors. The wireless communication interface can transmit, using a wireless connection with a remote device, one or more data elements to the remote device. The one or more processors can identify a condition of the wireless connection, determine a rate, for transmission of the one or more data elements, based at least on the condition, retrieve a signal from the remote device indicative of at least one criterion for use of the one or more data elements, update the rate based at least on the at least one criterion to determine an updated rate for transmission of the one or more data elements to the remote device, and cause the wireless communication interface to transmit, at the updated rate, the one or more data elements to the remote device

In some implementations, a device includes a wireless communication interface and one or more processors. The one or more processors can identify a rate control condition and provide a signal to a remote device indicative of a target rate for receiving data packets according to the rate control condition. In some implementations, the target rate is indicated as a range of rates. In some implementations, the receiving device determines the signal based at least on one or more of a latency criteria or a throughput criteria. In some implementations, the receiving device determines the signal based at least on a characteristic of the data packets and/or a characteristic of an application to receive data of the data packets.

Although various implementations disclosed herein are provided with respect to wearable devices, principles disclosed herein can be applied to any other type of devices such as handheld, mobile or small form factor devices (e.g., smart phones, tablet computers, laptops, etc.).

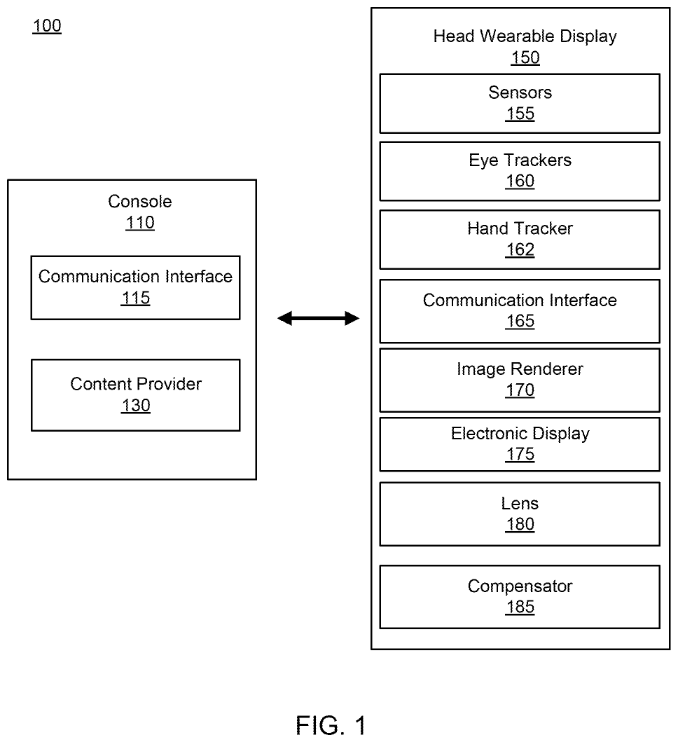

FIG. 1 is a block diagram of an example artificial reality system environment 100. In some implementations, the artificial reality system environment 100 includes a HWD 150 worn by a user, and a console 110 providing content of artificial reality to the HWD 150. The HWD 150 may be referred to as, include, or be part of a head mounted display (HMD), head mounted device (HMD), head wearable device (HWD), head worn display (HWD) or head worn device (HWD). The HWD 150 may detect its location and/or orientation of the HWD 150 as well as a shape, location, and/or an orientation of the body/hand/face of the user, and provide the detected location/or orientation of the HWD 150 and/or tracking information indicating the shape, location, and/or orientation of the body/hand/face to the console 110. The console 110 may generate image data indicating an image of the artificial reality according to the detected location and/or orientation of the HDM 150, the detected shape, location and/or orientation of the body/hand/face of the user, and/or a user input for the artificial reality, and transmit the image data to the HWD 150 for presentation. In some implementations, the artificial reality system environment 100 includes more, fewer, or different components than shown in FIG. 1. In some implementations, functionality of one or more components of the artificial reality system environment 100 can be distributed among the components in a different manner than is described here. For example, some of the functionality of the console 110 may be performed by the HWD 150. For example, some of the functionality of the HWD 150 may be performed by the console 110. In some implementations, the console 110 is integrated as part of the HWD 150.

In some implementations, the HWD 150 is an electronic component that can be worn by a user and can present or provide an artificial reality experience to the user. The HWD 150 may render one or more images, video, audio, or some combination thereof to provide the artificial reality experience to the user. In some implementations, audio is presented via an external device (e.g., speakers and/or headphones) that receives audio information from the HWD 150, the console 110, or both, and presents audio based on the audio information. In some implementations, the HWD 150 includes sensors 155, eye trackers 160, a hand tracker 162, a communication interface 165, an image renderer 170, an electronic display 175, a lens 180, and a compensator 185. These components may operate together to detect a location of the HWD 150 and a gaze direction of the user wearing the HWD 150, and render an image of a view within the artificial reality corresponding to the detected location and/or orientation of the HWD 150. In other implementations, the HWD 150 includes more, fewer, or different components than shown in FIG. 1.

In some implementations, the sensors 155 include electronic components or a combination of electronic components and software components that detect a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some implementations, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some implementations, the eye trackers 160 include electronic components or a combination of electronic components and software components that determine a gaze direction of the user of the HWD 150. In some implementations, the HWD 150, the console 110 or a combination of them may incorporate the gaze direction of the user of the HWD 150 to generate image data for artificial reality. In some implementations, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some implementations, the eye trackers 160 incorporate the orientation of the HWD 150 and the relative gaze direction with respect to the HWD 150 to determine a gate direction of the user. Assuming for an example that the HWD 150 is oriented at a direction 30 degrees from a reference direction, and the relative gaze direction of the HWD 150 is-10 degrees (or 350 degrees) with respect to the HWD 150, the eye trackers 160 may determine that the gaze direction of the user is 20 degrees from the reference direction. In some implementations, a user of the HWD 150 can configure the HWD 150 (e.g., via user settings) to enable or disable the eye trackers 160. In some implementations, a user of the HWD 150 is prompted to enable or disable the eye trackers 160.

In some implementations, the hand tracker 162 includes an electronic component or a combination of an electronic component and a software component that tracks a hand of the user. In some implementations, the hand tracker 162 includes or is coupled to an imaging sensor (e.g., camera) and an image processor that can detect a shape, a location and an orientation of the hand. The hand tracker 162 may generate hand tracking measurements indicating the detected shape, location and orientation of the hand.

In some implementations, the communication interface 165 includes an electronic component or a combination of an electronic component and a software component that communicates with the console 110. The communication interface 165 may communicate with a communication interface 115 of the console 110 through a communication link. The communication link may be a wireless link. Examples of the wireless link can include a cellular communication link, a near field communication link, WLAN/WiFi, Bluetooth, 60 GHz wireless link, or any communication wireless communication link. Through the communication link, the communication interface 165 may transmit to the console 110 data indicating the determined location and/or orientation of the HWD 150, the determined gaze direction of the user, and/or hand tracking measurement. Moreover, through the communication link, the communication interface 165 may receive from the console 110 image data indicating or corresponding to an image to be rendered and additional data associated with the image.

In some implementations, the image renderer 170 includes an electronic component or a combination of an electronic component and a software component that generates one or more images for display, for example, according to a change in view of the space of the artificial reality. In some implementations, the image renderer 170 is implemented as a processor (or a graphical processing unit (GPU)) that executes instructions to perform various functions described herein. The image renderer 170 may receive, through the communication interface 165, image data describing an image of artificial reality to be rendered and additional data associated with the image, and render the image through the electronic display 175. In some implementations, the image data from the console 110 may be encoded, and the image renderer 170 may decode the image data to render the image. In some implementations, the image renderer 170 receives, from the console 110 in additional data, object information indicating virtual objects in the artificial reality space and depth information indicating depth (or distances from the HWD 150) of the virtual objects. In one aspect, according to the image of the artificial reality, object information, depth information from the console 110, and/or updated sensor measurements from the sensors 155, the image renderer 170 may perform shading, reprojection, and/or blending to update the image of the artificial reality to correspond to the updated location and/or orientation of the HWD 150. Assuming that a user rotated his head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality. In some implementations, the image renderer 170 receives hand model data indicating a shape, a location and an orientation of a hand model corresponding to the hand of the user, and overlay the hand model on the image of the artificial reality. Such hand model may be presented as a visual feedback to allow a user to provide various interactions within the artificial reality.

In some implementations, the electronic display 175 is an electronic component that displays an image. The electronic display 175 may, for example, be a liquid crystal display or an organic light emitting diode display. The electronic display 175 may be a transparent display that allows the user to see through. In some implementations, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some implementations, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some implementations, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some implementations, the console 110 is an electronic component or a combination of an electronic component and a software component that provides content to be rendered to the HWD 150. In one aspect, the console 110 includes a communication interface 115 and a content provider 130. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 150 in a physical space into a virtual space (or simultaneous localization and mapping (SLAM) data), eye tracking data, motion vector information, depth information, edge information, object information, etc. The console 110 may provide the image data and the additional data to the HWD 150 for presentation of the artificial reality. In other implementations, the console 110 includes more, fewer, or different components than shown in FIG. 1. In some implementations, the console 110 is integrated as part of the HWD 150.

In some implementations, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., wireless link). Through the communication link, the communication interface 115 may receive from the HWD 150 data indicating the determined location and/or orientation of the HWD 150, the determined gaze direction of the user, and the hand tracking measurement. Moreover, through the communication link, the communication interface 115 may transmit to the HWD 150 image data describing an image to be rendered and additional data associated with the image of the artificial reality.

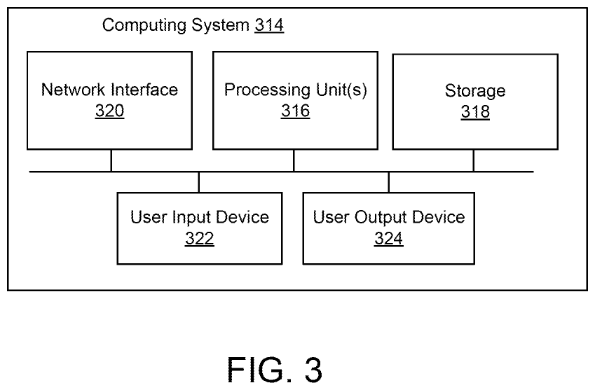

The content provider 130 can include or correspond to a component that generates content to be rendered according to the location and/or orientation of the HWD 150. In some implementations, the content provider 130 may incorporate the gaze direction of the user of the HWD 150, and a user interaction in the artificial reality based on hand tracking measurements to generate the content to be rendered. In one aspect, the content provider 130 determines a view of the artificial reality according to the location and/or orientation of the HWD 150. For example, the content provider 130 maps the location of the HWD 150 in a physical space to a location within an artificial reality space, and determines a view of the artificial reality space along a direction corresponding to the mapped orientation from the mapped location in the artificial reality space. The content provider 130 may generate image data describing an image of the determined view of the artificial reality space, and transmit the image data to the HWD 150 through the communication interface 115. The content provider 130 may also generate a hand model corresponding to a hand of a user of the HWD 150 according to the hand tracking measurement, and generate hand model data indicating a shape, a location, and an orientation of the hand model in the artificial reality space. In some implementations, the content provider 130 may generate additional data including motion vector information, depth information, edge information, object information, hand model data, etc., associated with the image, and transmit the additional data together with the image data to the HWD 150 through the communication interface 115. The content provider 130 may encode the image data describing the image, and can transmit the encoded data to the HWD 150. In some implementations, the content provider 130 generates and provides the image data to the HWD 150 periodically (e.g., every 11 ms). In one aspect, the communication interface 115 can adaptively transmit the additional data to the HWD 150 as described below with respect to FIGS. 3 through 6.

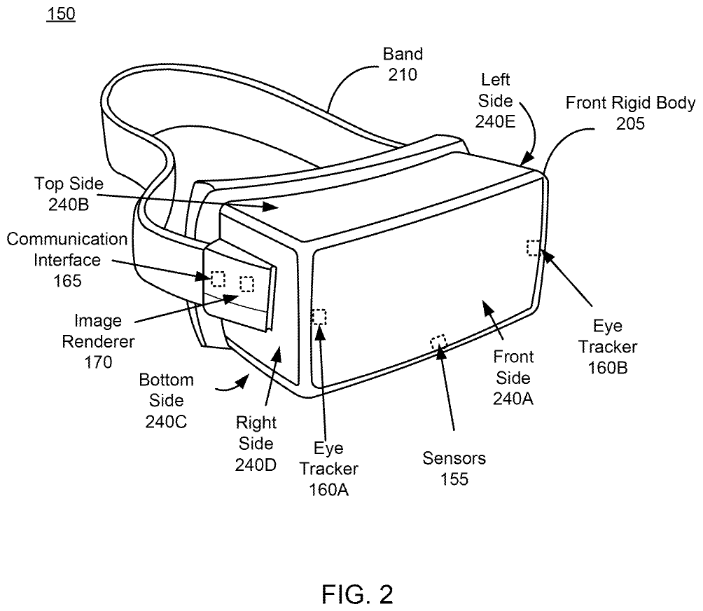

FIG. 2 is a diagram of a HWD 150, in accordance with an example implementation. In some implementations, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the implementation shown by FIG. 2, the communication interface 165, the image renderer 170, and the sensors 155 are located within the front rigid body 205, and may not be visible to the user. In other implementations, the HWD 150 has a different configuration than shown in FIG. 2. For example, the communication interface 165, the image renderer 170, the eye trackers 160A, 160B, and/or the sensors 155 may be in different locations than shown in FIG. 2.

Various operations described herein can be implemented on computer systems. FIG. 3 shows a block diagram of a representative computing system 314 usable to implement the present disclosure. In some implementations, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some implementations, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as WLAN/WiFi, Bluetooth, or cellular data network standards (e.g., 3G, 4G, 5G, 60 GHz, LTE, etc.).

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

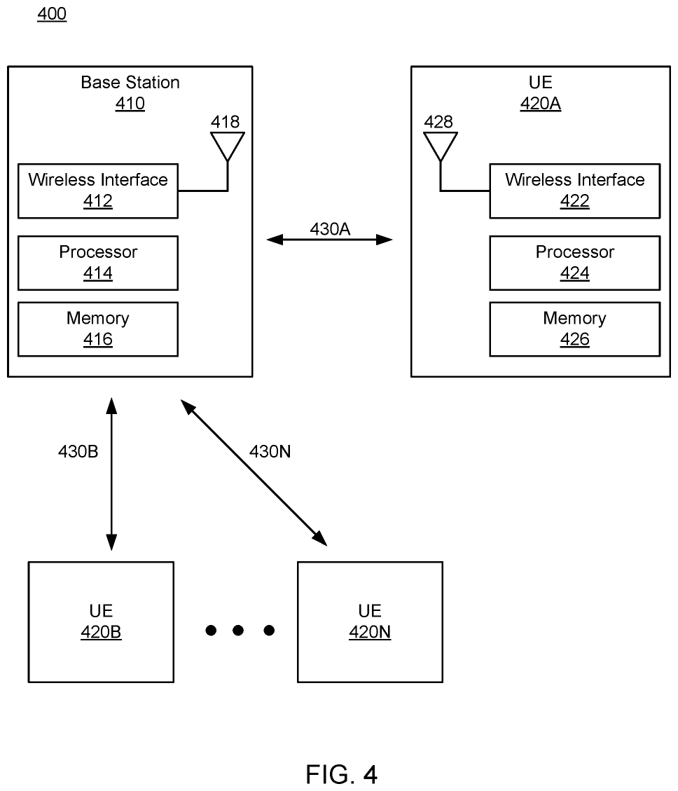

FIG. 4 illustrates an example wireless communication system 400. The wireless communication system 400 may include a base station 410 (also referred to as “a wireless communication node 410” or “a station 410”) and one or more user equipment (UEs) 420 (also referred to as “wireless communication devices 420” or “terminal devices 420”). The UEs 420 may be or include any device or component described above with reference to FIG. 1-FIG. 3, such as the console 110, head wearable display 150, or the like. The base station 410 and UEs 420 may include components, elements, and/or hardware similar to those described above with reference to FIG. 1-FIG. 3. The base station 410 and the UEs 420 may communicate through wireless commination links 430A, 430B, 430C. The wireless communication link 430 may be a cellular communication link conforming to 3G, 4G, 5G or other cellular communication protocols or a WLAN/WiFi communication protocol. In one example, the wireless communication link 430 supports, employs or is based on an orthogonal frequency division multiple access (OFDMA). In one aspect, the UEs 420 are located within a geographical boundary with respect to the base station 410, and may communicate with or through the base station 410. In some implementations, the wireless communication system 400 includes more, fewer, or different components than shown in FIG. 4. For example, the wireless communication system 400 may include one or more additional base stations 410 than shown in FIG. 4.

In some implementations, the UE 420 may be a user device such as a mobile phone, a smart phone, a personal digital assistant (PDA), tablet, laptop computer, wearable computing device, etc. Each UE 420 may communicate with the base station 410 through a corresponding communication link 430. For example, the UE 420 may transmit data to a base station 410 through a wireless communication link 430, and receive data from the base station 410 through the wireless communication link 430. Example data may include audio data, image data, text, etc. Communication or transmission of data by the UE 420 to the base station 410 may be referred to as an uplink communication. Communication or reception of data by the UE 420 from the base station 410 may be referred to as a downlink communication. In some implementations, the UE 420A includes a wireless interface 422, a processor 424, a memory device 426, and one or more antennas 428. These components may be embodied as hardware, software, firmware, or a combination thereof. In some implementations, the UE 420A includes more, fewer, or different components than shown in FIG. 4. For example, the UE 420 may include an electronic display and/or an input device. For example, the UE 420 may include additional antennas 428 and wireless interfaces 422 than shown in FIG. 4.

The antenna 428 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 428 may be a dipole antenna, a patch antenna, a ring antenna, or any suitable antenna for wireless communication. In one aspect, a single antenna 428 is utilized for both transmitting the RF signal and receiving the RF signal. In one aspect, different antennas 428 are utilized for transmitting the RF signal and receiving the RF signal. In one aspect, multiple antennas 428 are utilized to support multiple-in, multiple-out (MIMO) communication.

The wireless interface 422 includes or is embodied as a transceiver for transmitting and receiving RF signals through a wireless medium. The wireless interface 422 may communicate with a wireless interface 412 of the base station 410 through a wireless communication link 430A. In one configuration, the wireless interface 422 is coupled to one or more antennas 428. In one aspect, the wireless interface 422 may receive the RF signal at the RF frequency received through antenna 428, and downconvert the RF signal to a baseband frequency (e.g., 0˜1 GHZ). The wireless interface 422 may provide the downconverted signal to the processor 424. In one aspect, the wireless interface 422 may receive a baseband signal for transmission at a baseband frequency from the processor 424, and upconvert the baseband signal to generate a RF signal. The wireless interface 422 may transmit the RF signal through the antenna 428.

The processor 424 is a component that processes data. The processor 424 may be embodied as field programmable gate array (FPGA), application specific integrated circuit (ASIC), a logic circuit, etc. The processor 424 may obtain instructions from the memory device 426, and executes the instructions. In one aspect, the processor 424 may receive downconverted data at the baseband frequency from the wireless interface 422, and decode or process the downconverted data. For example, the processor 424 may generate audio data or image data according to the downconverted data, and present an audio indicated by the audio data and/or an image indicated by the image data to a user of the UE 420A. In one aspect, the processor 424 may generate or obtain data for transmission at the baseband frequency, and encode or process the data. For example, the processor 424 may encode or process image data or audio data at the baseband frequency, and provide the encoded or processed data to the wireless interface 422 for transmission.

The memory device 426 is a component that stores data. The memory device 426 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 426 may be embodied as a non-transitory computer readable medium storing instructions executable by the processor 424 to perform various functions of the UE 420A disclosed herein. In some implementations, the memory device 426 and the processor 424 are integrated as a single component.

In some implementations, each of the UEs 420B . . . 420N includes similar components of the UE 420A to communicate with the base station 410. Thus, detailed description of duplicated portion thereof is omitted herein for the sake of brevity.

In some implementations, the base station 410 may be an evolved node B (eNB), a serving eNB, a target eNB, a femto station, or a pico station. The base station 410 may be communicatively coupled to another base station 410 or other communication devices through a wireless communication link and/or a wired communication link. The base station 410 may receive data (or a RF signal) in an uplink communication from a UE 420. Additionally or alternatively, the base station 410 may provide data to another UE 420, another base station, or another communication device. Hence, the base station 410 allows communication among UEs 420 associated with the base station 410, or other UEs associated with different base stations. In some implementations, the base station 410 includes a wireless interface 412, a processor 414, a memory device 416, and one or more antennas 418. These components may be embodied as hardware, software, firmware, or a combination thereof. In some implementations, the base station 410 includes more, fewer, or different components than shown in FIG. 4. For example, the base station 410 may include an electronic display and/or an input device. For example, the base station 410 may include additional antennas 418 and wireless interfaces 412 than shown in FIG. 4. In some implementations, the base station 410 is or is coupled with an access point, such as a WLAN/WiFi access point.

The antenna 418 may be a component that receives a radio frequency (RF) signal and/or transmit a RF signal through a wireless medium. The antenna 418 may be a dipole antenna, a patch antenna, a ring antenna, or any suitable antenna for wireless communication. In one aspect, a single antenna 418 is utilized for both transmitting the RF signal and receiving the RF signal. In one aspect, different antennas 418 are utilized for transmitting the RF signal and receiving the RF signal. In one aspect, multiple antennas 418 are utilized to support multiple-in, multiple-out (MIMO) communication.

The wireless interface 412 includes or is embodied as a transceiver for transmitting and receiving RF signals through a wireless medium. The wireless interface 412 may communicate with a wireless interface 422 of the UE 420 through a wireless communication link 430. In one configuration, the wireless interface 412 is coupled to one or more antennas 418. In one aspect, the wireless interface 412 may receive the RF signal at the RF frequency received through antenna 418, and downconvert the RF signal to a baseband frequency (e.g., 0˜1 GHZ). The wireless interface 412 may provide the downconverted signal to the processor 424. In one aspect, the wireless interface 422 may receive a baseband signal for transmission at a baseband frequency from the processor 414, and upconvert the baseband signal to generate a RF signal. The wireless interface 412 may transmit the RF signal through the antenna 418.

The processor 414 is a component that processes data. The processor 414 may be embodied as FPGA, ASIC, a logic circuit, etc. The processor 414 may obtain instructions from the memory device 416, and executes the instructions. In one aspect, the processor 414 may receive downconverted data at the baseband frequency from the wireless interface 412, and decode or process the downconverted data. For example, the processor 414 may generate audio data or image data according to the downconverted data. In one aspect, the processor 414 may generate or obtain data for transmission at the baseband frequency, and encode or process the data. For example, the processor 414 may encode or process image data or audio data at the baseband frequency, and provide the encoded or processed data to the wireless interface 412 for transmission. In one aspect, the processor 414 may set, assign, schedule, or allocate communication resources for different UEs 420. For example, the processor 414 may set different modulation schemes, time slots, channels, frequency bands, etc. for UEs 420 to avoid interference. The processor 414 may generate data (or UL CGs) indicating configuration of communication resources, and provide the data (or UL CGs) to the wireless interface 412 for transmission to the UEs 420.

The memory device 416 is a component that stores data. The memory device 416 may be embodied as RAM, flash memory, ROM, EPROM, EEPROM, registers, a hard disk, a removable disk, a CD-ROM, or any device capable for storing data. The memory device 416 may be embodied as a non-transitory computer readable medium storing instructions executable by the processor 414 to perform various functions of the base station 410 disclosed herein. In some implementations, the memory device 416 and the processor 414 are integrated as a single component.

In some implementations, communication between the base station 410 and the UE 420 is based on one or more layers of Open Systems Interconnection (OSI) model. The OSI model may include layers including: a physical (PHY) layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer(s). For example, for WLAN/WiFi communication, the UEs 420 and/or base station 410 (or other components) can establish a wireless connection amongst each other for transmitting (and receiving) data at the PHY layer, where the transmitted data is configured by operations from various layers of the OSI model.

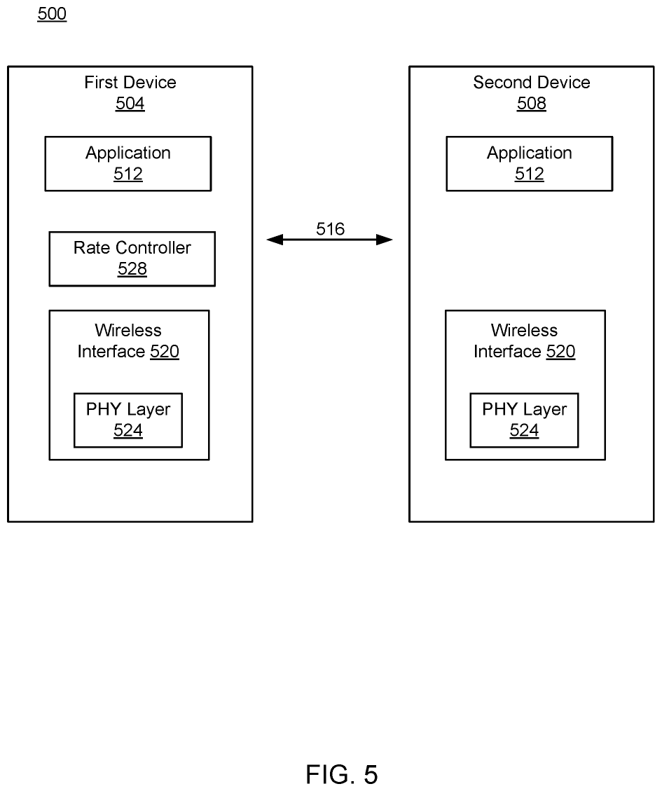

Referring now to FIG. 5, depicted is a block diagram of a system 500 that can implement operations including network communications, such as with guided rate adaptation, according to an example implementation of the present disclosure. The system 500 can include a first device 504 (e.g., a UE 420 and/or access point) and a second device 508 (e.g., a UE 420 and/or access point).

The first and second devices 504, 508 can execute an application 512. In various implementations, the application 512 may be an extended reality (XR) application (e.g., an augmented reality (AR), virtual reality (VR), mixed reality (MR), or other XR application). The application 512 executing on the first device 504 can generate data for transmission to the second device 508 (and vice versa). The first and second devices 504, 508 can transmit the data along a wireless connection 516, such as a WLAN or WiFi connection. In some implementations, one or both of the first and second devices 504, 508 communicate with additional devices for implementation of the application 512. The wireless connection 516 can be or include one or more WLAN/WiFi communication channels.

As depicted in FIG. 5, the first and second devices 504, 508 can each have a respective wireless interface 520 (e.g., WLAN/WiFi radio, WLAN/WiFi chipset) including a physical layer 524. The physical layer 524 can receive data (e.g., data packets) from the application 512 and transmit the data over the wireless connection 516 to the other of the first and second devices 504, 508. The physical layer 524 can transmit the data at a physical rate (PHY rate). The wireless interface 520 can be used for the first and second devices 504, 508 to communicate in infrastructure modes (e.g., where the second device 508 is an access point) and/or peer-to-peer modes (e.g., where the second device 508 is a UE).

The first device 504 (and/or the second device 508) can include a rate controller 528 to control operation of the wireless interface 520, such as to perform various rate adaptation operations to control, e.g., optimize, at least one of the PHY rate or the MCS used for the PHY rate. The rate controller 528 can control the PHY rate based at least on conditions of the wireless connection 516. The condition can include at least one of signal to noise ratio (SNR) or signal to interference and noise ratio (SINR). The condition of the wireless connection 516 can be affected by various factors. As an example, it can be useful to incorporate multiple wireless communication radios in a relatively small space in the first device 504, such as to reduce size and/or weight of the first device 504. In various forms, the radios may interfere with each other, which can affect the quality of the user experience due to wireless performance degradation, such as measured in terms of throughput, packet error rate, latency and jitter, etc. The MCS can be an identifier/scheme/configuration to indicate one or more parameters (e.g., given one or more measured parameters or thresholds in a lookup table) for wireless communication. The one or more parameters and/or thresholds can include at least one of a modulation type (e.g., binary phase-shift keying (BPSK), quadrature phase-shift keying (QPSK), quadrature amplitude modulation (QAM) (e.g., 16-QAM, 64-QAM, 256-QAM)), a coding scheme (e.g., indicative of rate of bits transferred and forward error correction (FEC), such as 1/2 coding (where two bits are transferred and one is received), 3/4, 5/6), a data rate, a minimum SNR or SINR, a guard interval, a channel width, or a received signal strength indicator (RSSI).

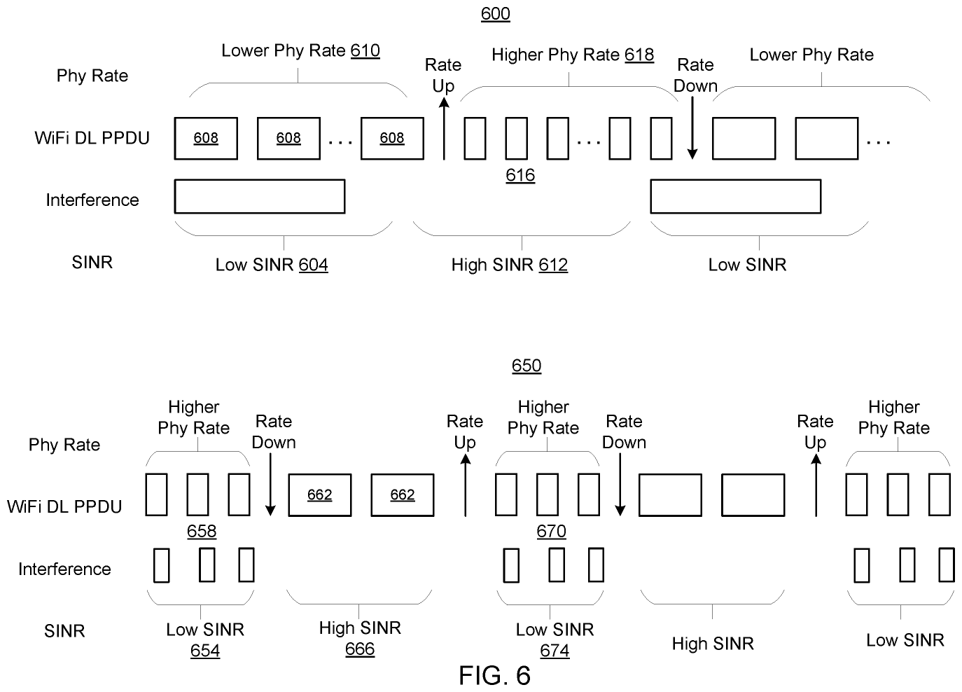

FIG. 6 depicts a rate adaptation process 600 that can be implemented by the first device 504 for transmitting data to the second device 508. The rate controller 528 can perform rate adaptations, such as increasing or decreasing the PHY rate, based at least on the condition of the wireless connection 516. As depicted for the process 600, the rate controller 528, in response to a low SINR condition 604, can transmit first data elements 608 (e.g., WLAN/WiFi downlink (DL) physical layer protocol data units (PPDUs)) at a first, relatively low PHY rate 610 in response to detection of the low SINR condition 604. In response to detecting a second condition 612, such as a relatively high SINR condition 612 (e.g., greater than a threshold value indicative of nominal and/or high performance conditions), the wireless interface 520 can increase the PHY rate to generate and transmit second data elements (e.g., WLAN/WiFi DL PPDUs) 616 at a second, relatively high PHY rate 618. As depicted in FIG. 6, the rate controller 528 can periodically evaluate the conditions, etc., to select the PHY rate for data packet transmission. This can be useful in instances in channel environments that have relatively long coherence time to adapt to different signal to noise ratio (SNR) and/or signal to interference & noise (SINR) conditions, as depicted in FIG. 6. For example, the WLAN/WiFi PHY rate adaptation performed by the rate controller 528 can adapt to different channel conditions based on a predefined SINR and/or packet error rate (PER) (e.g., using respective thresholds for one or more of SNR, SINR, and PER to select the PHY rate), and can quickly converge to a target or rate for the corresponding channel conditions. For example, as shown for process 600, the rate controller 528 can select the appropriate PHY rate in time for the PHY rate to be useful for the channel conditions during which the data packets are transmitted (e.g., data packets are transmitted at high PHY rate during high SINR and low PHY rate during low SNR).

As depicted in FIG. 6 for process 650, WLAN/WiFi rate adaptations such as shown for process 600, in some instances, may result in operations that may decrease the quality of the user experience. For example, under fast changing channel conditions, when the channel coherence time is much shorter compared to the rate adaptation PER averaging window size, the rate adaptation can have challenges in converging on optimal MCSs, which can result in the rate controller 528 continually attempting to use different PHY rates without achieving a PHY rate useful for the current conditions. In low latency applications, such as XR applications, latency can be a sensitive metric, and can directly impact user experience. The WLAN/WiFi rate adaption performed by the rate controller 528 can attempt to use as high of a modulation coding scheme (MCS) as possible, such as to achieve a threshold (e.g., highest or target) throughput.

The high MCS selection can be useful for throughput but not for latency, as higher MCSs can have higher PER, which can lead to potentially greater latency. In in-device coexistence (IDC) issues (e.g., across all MCSs), in XR devices, there can be multiple radios of the wireless interface 520 working concurrently (e.g., with 2.4 GHZ WLAN/WiFi), which can cause IDC issues, some of which can present challenges to all MCSs. For example, when a radio (e.g., BT) takes over the front end module from the 2.4 GHZ WLAN/WiFi receiver, packet drop can be expected regardless of the MCS used on the transmitter side. Such IDC issues can impact the WLAN/WiFi reception throughput because the rate adaptation as implemented by the rate controller 528 may result in the rate controller 528 downgrading all the way to the lowest MCSs, yet may not achieve a target PER value.

For example, as depicted for process 650, in response to a low SINR condition 654 detecting during transmittal of first data elements 658, the rate controller 528 can decrease the PHY rate to generate and transmit second data elements 662 at a lower rate. However, by the time the second data elements 662 are transmitted (e.g., by the time the rate controller 528 detects the low SINR condition 654 and processes the detection to determine to decrease the PHY rate), the channel conditions have changed to a high SINR condition 666, in which case the rate controller 528 operates with low performance in transmitting the second data elements 662 at the lower PHY rate during the high SINR condition 666 (when the higher PHY rate could be used for the second data elements 662). As further depicted in FIG. 6, responsive to detecting the high SINR condition 666, the rate controller 528 can determine to transmit third data packets 670 at the high PHY rate; however, again the channel conditions have changed to a low SINR condition 674, resulting in a mismatch (once more) between the PHY rate and channel conditions.

To address various such considerations, the rate controller 528 can perform the rate adaptation based at least on an advisory signal from a remote device, such as from the second device 508 to which first device 504 is to transmit the data. For example, the rate controller 528 can implement a peer-advised WLAN/WiFi rate adaptation mechanism, which can provide enhancements for scenarios that involve various performance considerations, such as latency-sensitive scenarios (e.g., where low latency is a useful or high priority criterion to achieve) or throughput-sensitive scenarios (e.g., where high throughput is a useful or high priority criterion to achieve). In some implementations, the rate controller 528 selects at least one of the PHY rate or an MCS based at least on the advisory signal. The rate controller 528 can perform adaptations including at least one of stepping down to a rate, stepping down to a range of rates, or proposing a rate or range of rates, given the advisory signal.

For example, responsive to detecting a latency-sensitive condition, the second device 508 can generate the advisory signal to indicate at least one of the latency-sensitive condition or an instruction to use a low PER target. The second device 508 can detect the latency-sensitive condition based on evaluating various factor(s), such as a type of data being received or application being used to process the received data.

Responsive to receiving the advisory signal (and, in some implementations, to detecting that the SINR is less than a target threshold), the rate controller 528 can select the at least one of the PHY rate or the MCS to satisfy the low PER target, such as to use a low MCS. Due to the information provided by second device 508 in the advisory signal, the rate controller 528 can more rapidly (e.g., due to the information regarding the operations being performed and/or channel conditions that the first device 504 may not have) converge to a useful PHY rate and/or MCS, such as a low MCS, to achieve the low PER target to meet quality of experience for the latency-sensitive condition.

As an example, responsive to detecting a throughput-sensitive condition, the second device 508 can generate the advisory signal to indicate at least one of the throughput-sensitive condition or an instruction to use a high PER target. The second device 508 can detect the throughput-sensitive condition based on evaluating various factor(s), such as a type of data being received or application being used to process the received data.

Responsive to receiving the advisory signal (and, in some implementations, to detecting that the SINR is greater than a target threshold), the rate controller 528 can select the at least one of the PHY rate or the MCS to satisfy the high PER target, such as to use a relatively high MCS. Due to the information provided by second device 508 in the advisory signal, the rate controller 528 can more rapidly (e.g., due to the information regarding the operations being performed and/or channel conditions that the first device 504 may not have) converge to a useful PHY rate and/or MCS, such as a high MCS, to achieve the high PER target to meet quality of experience for the throughput-sensitive condition. For example, the rate controller 528, responsive to receiving the advisory signal that indicates the at least one of the high PER target or the throughput-sensitive condition, can persist longer at a higher MCS than would be performed without the advisory signal (e.g., to give higher weight to selection of higher MCSs for better throughput). This can allow for improved WLAN/WiFi reception throughput at the second device 508 by leveraging possible airtime given duty cycle from interference signals.

In various such implementations, the rate controller 528, using the information provided by the second device 508 in the advisory signal, can have the default rate adaptation processes enhanced, such as by being provided dynamic information indicative of different PER targets depending on latency or throughput needs. For example, by tuning the PER target, the rate controller 528 can be guided to give greater weight to high MCSs for better throughput, or low MCSs for better latency performance. In some implementations, the rate controller 528 determines an initial rate adaptation (e.g., PHY rate and/or MCS) according to the detection of the channel condition, and updates the initial rate adaptation according the advisory signal (e.g., decrease or increases the PHY rate and/or MCS according to the advisory signal).

In some implementations, the advisory signal is represented using a data structure, such as a two-bit data structure shown in Table 1 below:

TABLE 1
Data Structure for Rate Adaptation Advisory Signal

| (B0, B1) Value | Indication Definitions |
|---|---|
| (0, 0) | Use default PER target per rate adaptation |
| (0, 1) | User lower PER target for rate adaptation to |
| | select lower MCSs |
| (1, 0) | Use higher PER target for rate adaptation to |
| | persist longer on higher MCSs |
| (1, 1) | N/A |

To facilitate effective communication of the advisory signal, the data structure can be included in any of various signaling approaches. This can include, for example, in a MAC header, such as an A-control field of HE variant of HT control field.

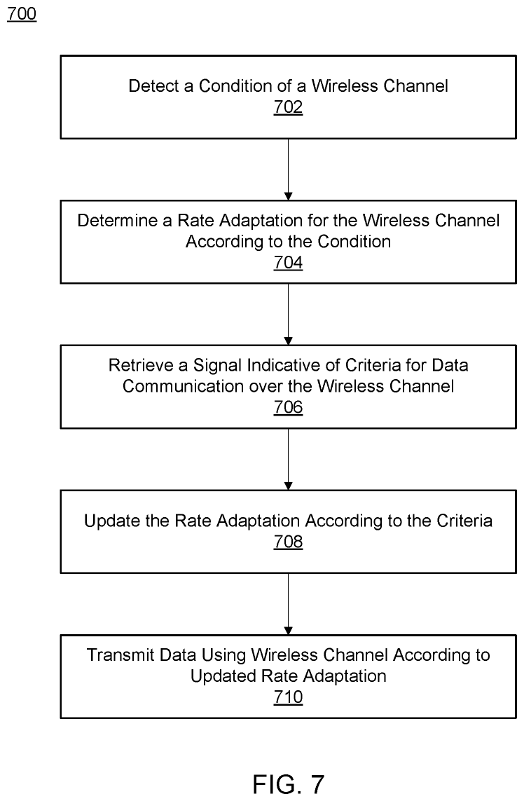

FIG. 7 shows a flow diagram of a representative method 700 of rate adaptation. In some implementations, the method 700 can be implemented by a device, such as a UE, configured to communicate with a second device, such as remote UE or access point, using a wireless connection. In some implementations, the method can be implemented for communication between UEs, or for communication from a access point to a UE (or vice versa). In brief overview, the method can include detecting 702 a condition of the wireless connection. The method can include determining 704 a rate adaptation according to the channel condition. The method can include retrieving 706 a signal indicative of a criterion for data transmission over the wireless connection. The method can include updating 708 the rate adaptation according to the signal. The method can include transmitting 710 one or more data packets using the wireless connection according to the updated rate adaptation. In some implementations, the method 700 can be performed by the wearable device 110 or the wearable device 150. In some implementations, the method 700 can be performed by other entities. In some implementations, the method 700 includes more, fewer, or different steps than shown in FIG. 7.

Referring to FIG. 7 in further detail, one or more processors of the first device can detect/determine 702 a condition of a wireless connection between the first device and a second device. The condition can be a channel condition of one or more channels of WLAN/WiFi communication between the first device and the second device. The one or more processors can detect the condition responsive to evaluating a characteristic of the wireless connection, such as at least one of SNR or SINR. For example, the one or more processors can compare the characteristic to one or more thresholds (e.g., a single threshold to distinguish low SINR and high SINR; a plurality of thresholds corresponding to multiple categories of conditions) and determine the condition responsive to the comparison, such as to determine a low SINR condition or a high SINR condition responsive to the comparison. For example, the one or more processors can determine the condition to be a low SINR condition responsive to the SINR being less than a threshold, or can determine the condition to be a high SINR condition responsive to the SINR being greater than the threshold.

The one or more processors can determine 704 a rate adaptation (e.g., an initial rate adaptation) according to the detected condition. The rate adaptation can include at least one of a selection of a data communication rate, such as PHY rate, or a selection of an MCS. In some implementations, the rate adaptation includes a selection corresponding to an increase of rate or decrease of rate. For example, responsive to detecting the condition to be the low SINR condition, the one or more processors can determine the rate adaptation to be a decrease in rate and/or MCS relative to a default rate and/or MCS. Responsive to detecting the condition to be the high SINR condition, the one or more processors can determine the rate adaptation to be a selection of the default rate and/or MCS and/or an increase in rate and/or MCS.

In some implementations, the one or more processors perform the rate adaptation responsive to a change in the detected condition. For example, the one or more processors can maintain a current data communication rate (e.g., PHY rate and/or MCS) until at least one of (1) the detected condition changes from a first condition to a second condition (e.g., from nominal or high SINR to low SINR or vice versa) or (2) a value of the detected condition changes relative to a threshold (e.g., SINR decreases below a low SINR threshold or increases above a high SINR threshold).

The one or more processors can retrieve 706 a signal indicative of a criterion for data transmission over the wireless connection. In some implementations, the one or more processors request the signal from the second device. In some implementations, the one or more processors periodically receive the signal from the second device. The one or more processors can retrieve the signal responsive to determining the rate adaptation and/or responsive to detecting that the condition is at least one of a low SINR condition or a high SINR condition (e.g., responsive to detecting the condition to be such that rate adaptation is to be performed). The one or more processors can retrieve the signal, and can retrieve the criterion from the signal, at various points in time relative to determining the rate adaptation. For example, the one or more processors can retrieve the criterion responsive to each instance (or at a lesser rate than each instance) of one or more of identifying the condition of the wireless connection, determining the rate adaptation, and/or receiving the signal. In some implementations, the remote device selectively indicates the criterion, such as to indicate the criterion responsive to detecting a latency-sensitive use for the data to be received or responsive to detecting a throughput-sensitive use for the data to be received; where such conditions are not present, the remote device may indicate that no further modification to the rate adaptation is to be performed (e.g., using a bit code corresponding to such instructions). In some implementations, the device from which the signal is received is different than the device that is to receive the data.

The criterion for data transmission can correspond to at least one of a performance target or quality of experience target for the data transmission. For example, the criterion for data transmission can include at least one of an identifier of the performance target or of an application or use for the data to be transmitted. For example, the criterion can indicate that the data is latency-sensitive, or can indicate that the data is throughput-sensitive. In some implementations, the second device (e.g., the device that is to receive the data from the first device) generates the signal responsive to evaluating the criterion, such as to indicate that the data is to be transmitted for use in a latency-sensitive application, or to indicate that the data is to be transmitted for use in a throughput-sensitive application. In some implementations, the second device generates the signal to indicate a modification to the rate adaptation, such as to use the determined (e.g., default) rate adaptation, or to increase or decrease at least one of a PHY rate or MCS of the determined rate adaptation. Increasing the PHY rate and/or MCS can be performed for throughput-sensitive applications. Decreasing the PHY rate and/or MCS can be performed for latency-sensitive applications, such as to decrease the PER associated with data transmission and reception.

The one or more processors can update 708 (e.g., perform, adjust, modify) the rate adaptation according to the signal. For example, responsive to the signal being indicative of latency-sensitive operation, the one or more processors can select a lower PHY rate and/or MCS relative to that of the initial rate adaptation. Responsive to the signal being indicative of throughput-sensitive operation, the one or more processors can select a higher PHY rate and/or MCS relative to that of the initial rate adaptation, such as to persist operation with a relatively higher PHY rate and/or MCS. In some implementations, the one or more processors periodically update the rate adaptation responsive to periodically retrieving (and evaluating the data of) the signal. Due to the use of the signal, the one or more processors can more rapidly (e.g., in less time; in fewer transmission cycles) converge to a rate that matches the channel conditions and performance criteria for the use of the data to be transmitted.

The one or more processors can transmit 710 one or more data packets according to the updated rate adaptation. For example, the one or more processors can cause the wireless communication interface to transmit the one or more data packets according to the at least one of the PHY rate or the MCS of the updated rate adaptation. The one or more processors can iteratively receive data packets for transmission from an application of the first device and cause transmission of the data packets according to a currently determined rate adaptation for the transmission.

Some implementations include electronic components, such as microprocessors, storage and memory that store computer program instructions in a computer readable storage medium (e.g., non-transitory computer readable medium). Many of the features described in this disclosure can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, the processors 316 can provide various functionality for the computing system 314, including any of the functionality described herein as being performed by a server or client, or other functionality associated with message management services.

It will be appreciated that the computing system 314 is illustrative and that variations and modifications are possible. Computer systems used in connection with the present disclosure can have other capabilities not specifically described here. Further, while the computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the implementations disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary implementations, and that such variations are intended to be encompassed by the present disclosure.

What is claimed is:

1. A device comprising:
a wireless communication interface to transmit, using a wireless connection with a remote device, one or more data elements to the remote device; and
one or more processors to:
identify a condition of the wireless connection;
determine a rate, for transmission of the one or more data elements, based at least on the condition;
retrieve a signal from the remote device indicative of at least one criterion for use of the one or more data elements;
update the rate based at least on the at least one criterion to determine an updated rate for transmission of the one or more data elements to the remote device; and
cause the wireless communication interface to transmit, at the updated rate, the one or more data elements to the remote device.

2. The device of claim 1, wherein the at least one criterion comprises at least one of a packet error rate, a latency criterion, or a throughput criterion, and the one or more data elements correspond to video data.

3. The device of claim 1, wherein the one or more processors are to identify the condition based on at least one of a signal to noise ratio (SNR) of the wireless connection or a signal to interference and noise ratio (SINR) of the wireless connection.

4. The device of claim 1, wherein:
the wireless communication interface comprises a wireless local area network (WLAN) radio; and
the one or more processors are to determine the rate, based at least on the condition, as a selection of a modulation coding scheme (MCS) for WLAN communication over the wireless connection.

5. The device of claim 4, wherein the one or more processors are to update the rate by selecting a higher MCS responsive to the at least one criterion indicating a throughput-sensitive use for the one or more data elements.

6. The device of claim 4, wherein the one or more processors are to update the rate by selecting a lower MCS responsive to the at least one criterion indicating a latency-sensitive use for the one or more data elements.

7. The device of claim 1, wherein the one or more processors are to retrieve the at least one criterion from a two bit data structure in a header of the signal from the remote device.

8. A system, comprising:
one or more processors to:
identify a condition of a wireless connection with a remote device;
determine a rate, for transmission of the one or more data elements, based at least on the condition;
retrieve a signal indicative of at least one criterion for use of the one or more data elements;
update the rate based at least on the at least one criterion to determine an updated rate for transmission of the one or more data elements to the remote device; and
cause a wireless communication interface to transmit, at the updated rate, the one or more data elements to the remote device.

9. The system of claim 8, wherein the at least one criterion comprises at least one of a packet error rate, a latency criterion, or a throughput criterion.

10. The system of claim 8, wherein the one or more processors are to identify the condition based on at least one of a signal to noise ratio (SNR) of the wireless connection or a signal to interference and noise ratio (SINR) of the wireless connection.

11. The system of claim 8, wherein the one or more processors are to determine the rate, based at least on the condition, as a selection of a modulation coding scheme (MCS) for wireless local area network (WLAN) communication over the wireless connection.

12. The system of claim 11, wherein the one or more processors are to update the rate by selecting a higher MCS responsive to the at least one criterion indicating a throughput-sensitive use for the one or more data elements.

13. The system of claim 11, wherein the one or more processors are to update the rate by selecting a lower MCS responsive to the at least one criterion indicating a latency-sensitive use for the one or more data elements.

14. The system of claim 11, wherein the one or more processors are to retrieve the at least one criterion from a header of the signal from the remote device.

15. A method, comprising:
detecting, by one or more processors, a condition of a wireless connection with a remote device;
determining, by the one or more processors, based at least on the condition, a rate for transmission of the one or more data elements;
retrieving, by the one or more processors, a signal indicative of at least one criterion for use of the one or more data elements;
updating, by the one or more processors, the rate based at least on the at least one criterion to determine an updated rate for transmission of the one or more data elements to the remote device; and
causing, by the one or more processors, a wireless communication interface to transmit, at the updated rate, the one or more data elements to the remote device.

16. The method of claim 15, wherein the at least one criterion comprises at least one of a packet error rate, a latency criterion, or a throughput criterion.

17. The method of claim 15, further comprising detecting, by the one or more processors, the condition based on at least one of a signal to noise ratio (SNR) of the wireless connection or a signal to interference and noise ratio (SINR) of the wireless connection.

18. The method of claim 15, further comprising determining the rate, by the one or more processors based at least on the condition, as a selection of a modulation coding scheme (MCS) for wireless local area network (WLAN) communication over the wireless connection.

19. The method of claim 18, further comprising updating, by the one or more processors, the rate by selecting a higher MCS responsive to the at least one criterion indicating a throughput-sensitive use for the one or more data elements.

20. The method of claim 18, further comprising updating, by the one or more processors, the rate by selecting a lower MCS responsive to the at least one criterion indicating a latency-sensitive use for the one or more data elements.
